(19) United States
(12) Patent Application Publication
(10) Pub. No.: US 2002/0073211 A1
(43) Pub. Date: Jun. 13, 2002

(54) System and method for securely communicating between application servers and webservers

(76) Inventors: Raymond Lin, San Jose, CA (US); Hsienjywan Gordan Ko, Saratoga, CA (US); Wei Zhu, San Jose, CA (US)

Correspondence Address: David R. Stevens, Stevens & Westberg LLP, 99 North First Street, Suite 201, San Jose, CA, 95113, US

(21) Appl. No.: 09/735,570

(22) Filed: Dec. 12, 2000

(51) Int. Cl. G06F 15/16; G06F 15/173

(52) U.S. Cl. 709/229; 709/224; 709/203; 709/226

(57) ABSTRACT

A system and method are provided for facilitating secure communication between a web browser and an application server. An application server is able to actively send out requests to webservers to connect approved browsers for service sessions between the browsers and application servers. This is in contrast to passive operations of conventional application servers that allow browsers to actively access application servers for screening, leaving the application servers and other associated entities vulnerable to possible computer hackers. This is accomplished via a plurality of intermediate webservers that screen and route browser requests destined for particular application servers. The webservers are configured to communicate amongst each other to share status information related to communication sessions between browsers and application servers. The invention further includes a state server configured to store data related to communication sessions occurring among a web browser, a webserver and an application server, to allow one webserver to take over a session from another webserver in the event of a termination of a session monitored by a webserver.

### BACKGROUND

The invention generally relates to systems and methods for communicating with computer servers on a computer network, such as application servers operating with the Internet, and, more particularly, to a method and apparatus configured to securely facilitate communication sessions between web browsers and application servers.

Many systems and methods exist for connecting Internet browsers with Internet application servers. An Internet browser is an entity that communicates with other entities such as webservers connected to the Internet in search of information or services. A simple example is a person searching websites on the Internet to shop for goods or services. In a traditional client/server system, the communication protocols are based on a client-request/server-response model. In this model, the client, or Internet web-browser (“browser”), connects to a server connected to the network, such as the Internet, according to a well-defined protocol. The server, such as a webserver or an application server, then receives the browser request and processes it. In response, the server sends a result back to the browser. The result could take the form of a data file that can be displayed as content on a monitor, a software application that can perform certain tasks, or other data files that are commonly transferred over a network such as the Internet. Once the browser downloads the result, the process is complete. This transaction could occur between a browser and an application server as well as other entities.

Most systems and methods configured to perform this initial connection have at least one common attribute, when the client assessing the server sends a request to establish the initial connection, the server accepts it passively. This is required so that a server can collect enough client information to verify the client. At this point, security and performance may be at risk of being compromised. For example, when a client sends a request for access, a webserver must accept the request in order to verify the client. At this stage, the webserver is unable to determine whether the client connection is intended for a legitimate request from the server, or for an unfriendly intrusion to shut down the server or misappropriate valuable information.

Recently, this vulnerability of servers operating on the Internet has allowed computer hackers to attack a webserver by sending a large volume of requests, shutting some webservers down. Another problem with this vulnerability of servers is the risk of unauthorized access to the servers' sensitive information. Giving a hacker initial access to the server could open a server to intrusion into its information stored in memory. It would be useful if a system existed for pre-screening clients before they gain access to a server.

More recently, other configurations have been developed in order to handle a large number of browser requests. One method is to provide an intermediate webserver between a browser connection and an application server. This allows the webserver to control and route browser requests to an application server. Conventional applications, however, still accept browser requests passively, leaving the intermediate webservers and even the respective application servers vulnerable to attack by hackers. These hackers may shut down systems or infiltrate memory banks to misappropriate information. It has been attempted to use the intermediate webservers for screening browser requests to one or more application servers. However, these webservers are still vulnerable to attack, as they accept browser requests passively without screening them. In many business plans that employ this configuration, application servers are sold to customers, who are served browser requests by webservers that screen and route browser requests from browser ports to the application servers. These customers are not willing to allow their application servers to accept requests unless there is a secure connection with the webserver serving the request.

Typically, an application server would be protected by a firewall, which screens certain incoming requests, and a secure socket layer (SSL), both of which provide a limited amount of protection from outside requests. Introducing these safeguards into the system make product development and deployment very complicated. These proposed solutions also do not resolve the problem of passively accepting browser requests from the outside world.

Another solution is to use a virtual private network (VPN) to build a safety channel between the webserver that serves up browser requests and the application server that provides a service or delivers some type of result. VPNs are a means for using public network infrastructures, such as the Internet, to provide private, secure access to applications located within corporate network resources by remote employees, business partners and customers. Using the VPN, however, slows the process down a great deal while performing the security process to screen browser requests. The VPNs also require a large investment in software, hardware and possibly intellectual property licenses, adding a great deal of overhead to their application.

Therefore, there exists a need for a method and apparatus for better servicing web browsers, while maintaining secure connections with application service providers. As will be seen, the invention accomplishes this in an elegant manner.

### SUMMARY OF THE INVENTION

The invention provides a system and method for facilitating secure communication between a web browser and an application server. According to the invention, the application server is able to actively send out requests to webservers to connect approved browsers for service sessions between the browsers and application servers. This is in contrast to passive operations of conventional application servers that allow browsers to actively access application servers for screening, leaving the application servers and other associated entities vulnerable to possible computer hackers. This is accomplished via a plurality of intermediate webservers that screen and route browser requests destined for particular application servers. The invention may include a load balancing device that is configured to receive and screen browser requests from a computer network and to direct the requests among a plurality of webservers. The webservers are configured to communicate amongst each other to share status information related to communication sessions between browsers and application servers. The invention further includes a state server configured to store data related to communication sessions occurring among a web browser, a webserver and an application server.

According to the invention, a webserver may receive a browser request for an application server. The webserver must then wait for an application server to communicate to the webserver that it is willing to accept certain browser requests. Once that occurs, the browser is allowed to communicate with the application server, while being overseen by the webserver, which monitors the communications between the application server and the browser. In the event of the webserver shutting down its operation during a session between a browser and an application server, the state server retains the information related to the session. The application server, which retains the addresses of other webservers, can reconnect with another webserver and continue the session with the browser. The new webserver can then retrieve the session information from the state server and allow the session between the browser and the application server to continue.

### BRIEF DESCRIPTION OF THE DRAWINGS

FIG. 1 is a block diagram of a network system employing a web service system according to the invention;

FIG. 2 is a block diagram showing further details of the load balancer shown in FIG. 1;

FIG. 3 is a detailed block diagram of a webserver shown in FIG. 1;

FIG. 4 is a detailed block diagram of an application server as shown in FIG. 1;

FIG. 5 is a detailed block diagram of a state server shown in FIG. 1;

FIG. 6 is a functional block diagram of the system of FIG. 1 arranged to illustrate the flow of information;

FIG. 7 is a flowchart illustrating the function of the initiation of a browser and application server into the system according to the invention;

FIG. 8 is a flowchart illustrating the monitoring function of the webserver in monitoring an application server according to the invention;

FIG. 9 is a flowchart illustrating how a webserver monitors the pool status of an application server;

FIG. 10 is a flowchart illustrating how a webserver monitors the heartbeat for an application server according to the invention;

FIG. 11 is a flowchart illustrating the function of the application server verifying a webserver according to the invention;

FIG. 12 is a flowchart illustrating an application server's method of monitoring a webserver; and

FIG. 13 is a flowchart illustrating the recovery function when a webserver shuts down during a browser/application server session according to the invention.

### DETAILED DESCRIPTION OF THE INVENTION

The invention provides a system and method for facilitating secure communication between a web browser and an application server. Particularly, in one embodiment, the invention provides a configuration for an application server to be secure from potential unwanted browsers that may access the application server with an intent to misappropriate information or to possibly cause harm to a server, perhaps shutting a server down. According to the invention, the application server is able to actively send out requests to webservers to connect approved browsers for service sessions between the browsers and application servers. In prior art configurations, browsers are permitted to actively access application servers for screening, leaving the application servers and other associated entities vulnerable to possible computer hackers.

In one embodiment, protection from would be hackers is accomplished via a plurality of intermediate webservers that screen and route browser requests destined for particular application servers. Before sessions with browsers can begin, the webserver is configured to screen particular browsers according to certain criteria. For example, an application server may preauthorize certain browsers or a certain type of browser to access the application server. The browser would then access an associated webserver rather than directly access the application server itself. Then, the webserver waits for a signal from the application server indicating that it is ready to begin a browser session.

When the application server is ready to engage in a session with a browser, it may send a signal to a preauthorized webserver, authorizing it to establish a connection with a browser. The webserver can then begin a session between the application server and a browser. During the session, the webserver may monitor the session communications between the browsers and the application servers. That way, if a session is disrupted for some reason, it can be reestablished. To accomplish this, the invention may further include a state server configured to store data related to communication sessions occurring among a web browser, a webserver and an application server. In one embodiment, the webserver may send session information to the state server for storage. Session information may include certain commands or requests transferred between the browser and the application server, communication paths and other information related to the session. This information may be retrieved by another webserver to continue monitoring the ongoing session between the browser and the application server.

To manage incoming browser requests among one or more webservers, the invention may include a load balancing device that is configured to receive and screen browser requests from a computer network. The load balancer may then direct the requests among the plurality of webservers. The load balancer is configured to balance the incoming load of browser requests among the webservers. Once connected, the webservers may be configured to communicate amongst each other to share status information related to communication sessions between browsers and application servers.

According to the invention, in operation, a webserver may receive a browser request for an application server. This request may or may not first come through a load balancer in order to evenly distribute incoming browser requests among multiple webservers. Once the browser request has been received, the webserver receive an authorization signal form an application server, communicating to the webserver that it is willing to accept certain browser requests. Once that occurs, the webserver facilitates a communication connection that allows the browser to communicate with the application server. The webserver may then monitor the communications between the application server and the browser. During the monitoring of the session, the webserver may send session information to the state server, retaining records of session activities. This information may server as a log of activity between the browser and the application server, detailing the history of data transactions during a session. Such log information may include the time duration of the session, particular transactions that occurred and the order in which they occurred, identity of the browser, identity of the application server, identity of the webserver monitoring the session and other information. The log may contain different combinations and permutations of these types of information, as they are relevant to the application of the configuration.

In normal operation, there are times when webservers are taken out of service. Webservers may need service or maintenance, or may have an operational failure, rendering the webserver inoperable in the system. According to the invention, in the event of the webserver shutting down its operation during an ongoing session between a browser and an application server, the state server retains the logged information related to the session. The application server, which may retain the addresses of other webservers, can then reconnect with another webserver and continue the session with the browser. This may be a repeat of the original process where the new webserver must wait for an authorization signal from the application server before it can resume the session between the browser and the application server. According to the invention, the new webserver can retrieve the session information from the state server and configure itself according to the former session. Once the webserver, the application server and the browser are connected, the session between the browser and the application server may continue.

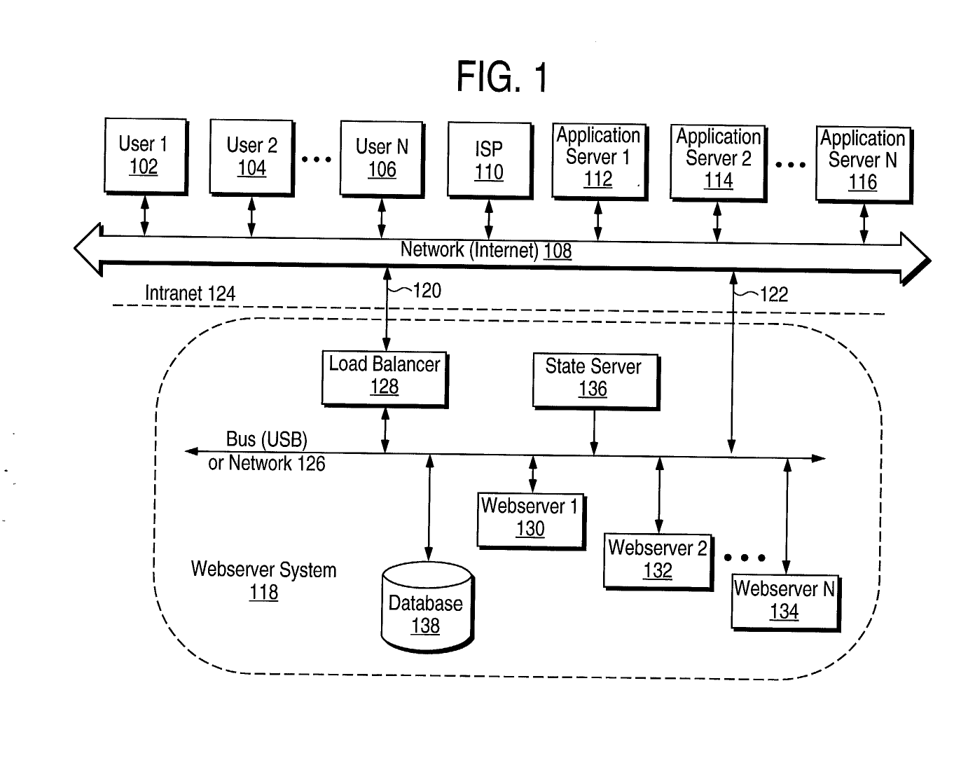

Referring to FIG. 1, an example of a system embodying the invention is illustrated. User computers 102-106 represent what could be a plurality of users connected to a network 108, such as the Internet. These users may be configured to operate as browsers on the network. In conventional systems, user computers communicate with each other via the Internet 108 by subscribing to an Internet service provider (ISP) 110. The ISP, among other capabilities, enables users connected to the Internet to communicate amongst themselves as well as other entities, such as webservers, application servers and other entities that provide information and services to Internet users. Many ISPs currently exist and communicate with the conventional Internet 108, providing services to entities that are able to communicate on the Internet.

According to the invention, a webserver system 118 communicates with the Internet 108 via communication ports 120, 122. These communication ports may be connections between modems (not shown) within webserver system 118 and an ISP 110 through the Internet 108. The webserver system may be located within an intranet 124, such as a LAN or other private network. Within this intranet 124, secure facilitation of connections between users 102-106 and application servers 112-116 can be achieved in a secure and efficient manner. In order for the users to access application servers, browser requests must be made to the webserver system 118 before a connection will be made to one or more application servers. Webserver system 118 may also include a common data BUS, such as a universal serial BUS (USB) 126 that allows interconnection among the components of the webserver system 118.

The system 118 further includes a load balancer 128 that allows communication between the network 108 and BUS 126. The load balancer is configured to receive browser requests from users 102-106 that are directed to one or more application servers 112-116. The system 118 further includes webservers 130-134 that may also communicate BUS 126, allowing communication among the load balancer 128, webservers 130-134, the network 108 and other components and entities communicating therewith.

At one level of operation, a user 102 communicating with network 108 may send a browser request for application server 112 to request information or services. The request is sent to ISP 110, in accordance with a service provision account between the user 102 and the ISP 110. The request is then relayed to the webserver system 118 via network 108 and communication connection 120, delivering the browser request to load balancer 128. The load balancer then relays the request to a webserver, such as webserver 130, for screening and routing to the ultimate destination, application server 112. Once the user 102 is screened by webserver 130, the system waits for application server 112 to contact the webserver system 118 to authorize the final connection between the user 102 and the application server 112 via the webserver system 118.

Giving the application server 112 the ability to actively authorize a user, such as user 102, access to the application server 112 removes the conventional passive acceptance of a browser request. In conventional systems, this connection would leave the application server 112 vulnerable to an unfriendly attack from users such as users 102-106, which may intend to shut down the application server 112 or misappropriate valuable information from the application server. These and other features are available when the invention is employed as a type of screening agent for the application servers, insulating them from unfriendly attacks by users.

According to the invention, the webserver system 118 may also include a state server 136 that is configured to monitor communication sessions between the users 102-106 and application servers 112-116 via one or more of the webservers 130-134. The state server 136 is configured to record session information for possible use in the recovery of a failed webserver during a session between a user and an application server. Upon a failure of a webserver, an application server, detecting a loss of connection between a user and the application server, may attempt to reconnect to the webserver in order to reestablish the connection and continue the session. If the webserver is shut down, a second webserver is assigned to pick up the session where it left off and facilitate further communication between the user and the application server. With this additional functionality, the webserver system 118 can provide reliable failure recovery and maintain ongoing sessions between users and application servers.

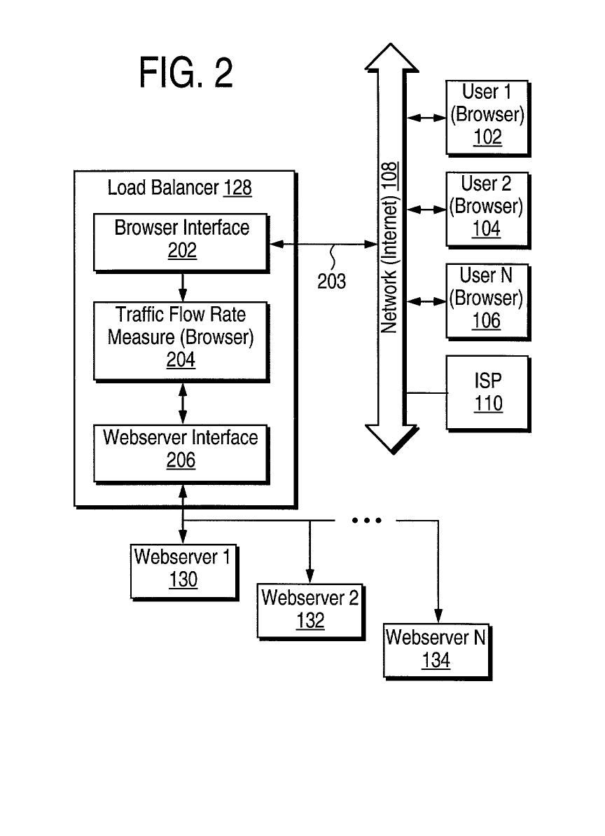

Referring to FIGS. 2-5, more detail block representations of the individual components of the webserver system 118 and application servers 112-116 are described. These components intercooperate to facilitate communication between users and application servers that is secure, fail-safe and efficient. These embodiments in the figures include discussions of communication means such as modems, but may also include other communications applications such as cable modems, DSL, T1 and other conventional types of communications media, circuit configurations, software applications, etc. Other types of communication links may exist between webservers and the application servers as well as between webservers and the users themselves. Dedicated communication links may also be employed among the entities described below for special applications. Other configurations may be possible by implementing other modern communication configurations and techniques. The terms application servers, state servers and webservers are used below to help organized the description of one embodiment of the invention. However, each of these components may be any type of individual computer that is configured to perform the functions of the embodiment. The functions and rolls of the components as described may change or even be interchanged among the several components in different configurations or embodiments. However, such changes would not depart from the spirit and scope of the invention. These figures illustrate one embodiment of the invention, but are not intended to limit the invention beyond that which is claimed below.

Beginning with FIG. 2, a detailed description of the load balancer 128 is illustrated. The load balancer includes a browser interface 202 as configured to communicate with network 108 via communication connection 203. The browser interface 202 may be a common modem or other communications means that communicates via a public or private telecommunication system to communicate with devices connected to the network 108. A traffic flow rate measuring module 204 communicates with the browser interface to monitor the data flow rate for each individual webserver connected to the load balancer. Using these measurement readings, the load balancer is able to distribute a flow of browser requests among the individual webservers 130-134 so as not to overload any one webserver.

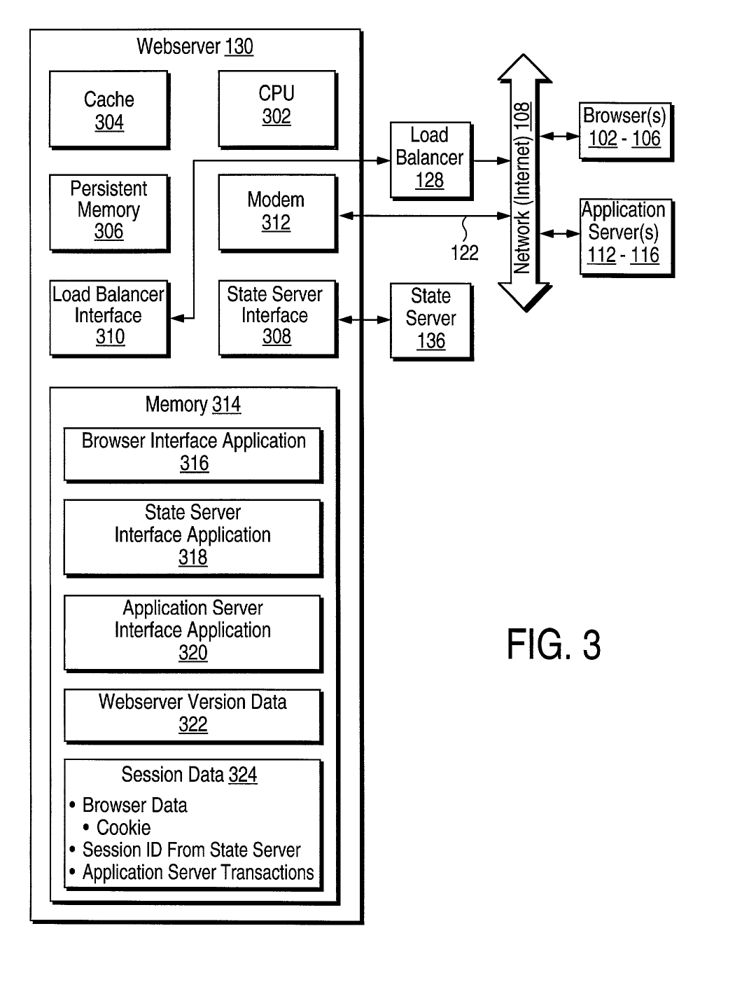

Referring to FIG. 3, a more detailed block diagram of webserver 130 is illustrated. Webserver 130 includes a central processing unit (CPU) 302 configured to control the interworkings of the webserver. The webserver further includes a cache memory 304 for storing information frequently retrieved by the CPU. Persistent memory 306 is also included for storing information commonly retrieved by the CPU, which may be often updated. State server interface 308 communicates with state server 136 to give the webserver access to information stored in the state server that pertains to sessions between users sending browser requests and application servers. This interface allows the webserver to create a monitoring thread between the webserver and the state server to facilitate recovery in the event of a webserver failure.

Load balancer interface 310 is connected to load balancer 128. The interface 310 is configured to communicate with the load balancer and receive browser requests distributed by the load balancer to the webserver as discussed above. The webserver may further include a modem 312, or other communication media as discussed above, as configured to communicate with the network 108 via communication link 122. The modem 312 is configured to exchange information among the webservers, the users and the application servers. The modem 312 may be a common telecommunication type modem configured to communicate with entities connected to the Internet via a common telephone link. The modem may also be a dedicated communication link with users and application servers within a private network. Other types of communication links may exist between the webserver and the application servers as well as between the webservers and the users themselves.

Webserver 130 further includes memory storage 314 for storing software applications and data related to functions performed by the webserver in accordance with the invention. The memory may be any type of volatile memory such as random access memory (RAM), flash memory, dynamic random access memory (DRAM), static random access memory (SRAM), or other volatile type memory in which digital data may be stored. Memory 314 may include browser interface application 316, including software code that is configured to facilitate communication between the webserver 130 and a browser(s) 102-106. This application 316 may allow the webserver to receive and store information from a browser pertaining verification of the browser, session information from the browser and other information pertaining to transactions between the browser and the application servers.

Memory 314 further includes the state server interface application 318 that includes software code that allows a webserver to form a link between the webserver and the state server 136. The state server interface application 318 may also enable the webserver 130 to create a thread between a webserver and a state server during a session and store information pertaining to that session. Application server interface application 320 is also included in memory 314 and may include software code that creates a mechanism to enable a webserver 130 to properly communicate with application servers 112-116. The mechanism may give the webserver the ability to receive signals from the application server, indicating that it is authorizing a connection with a webserver. This is described in more detail below.

Various data may be stored within memory 314 that pertains to communication sessions between users and application servers. Webserver version data 322 may include data pertaining to the version of the webserver and its applications for identification by the application servers and users. Session data 324 may also be stored in the memory. Session data may include browser data such as the Internet protocol address of a user and a cookie of the user, which further identifies the user submitting the request. Session data may also include the session identification, or ID, sent by the state server to identify the session in which a user in an application server communicates. The session data may also include application server transactions that occur between the users and the application servers during a session.

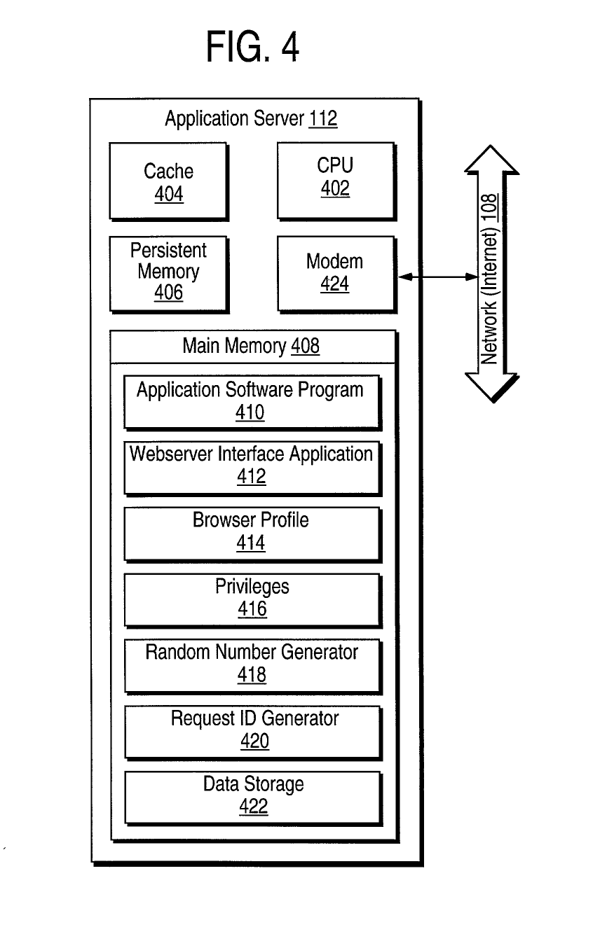

Referring to FIG. 4, a more detailed illustration of the application server 112 is shown. The application server includes a CPU 402 for controlling the inner workings of the application server including delivering information or services to a browser according to the invention. The application server further includes a cache memory 404 for storing information frequently stored and retrieved by the CPU from memory. Also included is persistent memory 406 for storing information frequently used by the CPU. Main memory 408 is configured to store digitally readable software code that pertains to the application provided by the application server and other software code and information. Application program software 410 is stored in main memory and includes computer readable software code that is used in delivering the application provided by the application server along with other information when executed by the CPU 402. The application server further includes a webserver interface application 412 configured to interface with the webserver according to the invention. This is discussed in more detail below. The webserver interface application further includes storage for a browser profile, defining information pertaining to a browser that engages in a session with the application server. Also included are privileges code 416 configured to establish access privileges for each browser or webserver to the application server. Random number generator 418 may also be included for establishing session identification for sessions occurring between an application server and a browser. Request ID generator 420 is also included to identify the particular request presented by the browser. Data storage 422 is also included to store other data pertaining to the functions of the application server.

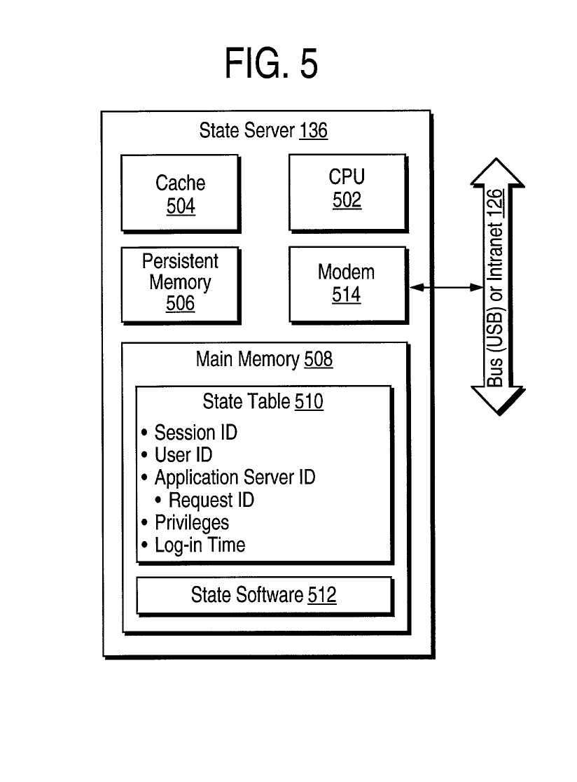

FIG. 5 is a detailed block diagram showing further details of a state server 136 according to the invention. The state server includes a CPU 502 for controlling the inner workings of the state server including monitoring sessions occurring between a browser and an application server with an intermediary webserver according to the invention. The state server includes a cache memory 504 for storing information frequently retrieved by the CPU from other storage devices. Persistent memory 506 is configured to store information frequently used by the CPU. Main memory 508 is configured to store information pertaining to the state of a webserver that services sessions between a browser and an application server. The main memory includes a state table 510 configured to store information pertaining to a particular session including a session ID, user ID identifying the browser, application server ID identifying the application server servicing the browser requests and a request ID identifying the type of request sent by browser during a session.

Privileges may also be stored in the state table 510 for defining the particular privileges that exist between a browser and an application server. Depending on the operation of the application server, a browser may have certain privileges that define limits to its access to the application server. Limits to certain information, certain commands a browser may send to the application server, session duration, and other limits to a browser may be defined by the privileges.

The log-in time may also stored in the state table for tracking the time over which the session occurs. State software 512 is also included in main memory and allows the CPU to perform the functions of the state server when executing the state software code. The state server further includes a modem 514, which could be any type of data interface circuit that is configured to interact with the bus 126 for sending information to other devices communicating with the bus.

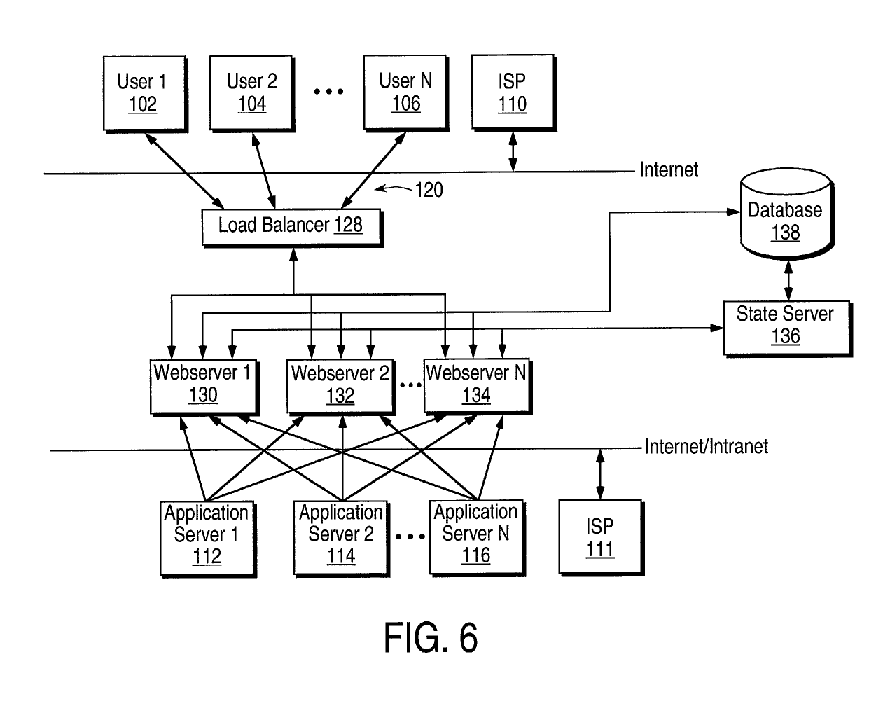

FIG. 6 illustrates a functional block diagram of the system shown in FIG. 1, but rearranged to illustrate the functional flow of data between users 102-106 and application servers 112-116. In operation, users, which are electronic entities sending browser requests intended for application servers, send these browser requests to the load balancer 128. Load balancer 128 distributes these requests from the users among the webservers 130-134 according to the availability of the webserver. The state server 136 monitors the webservers according to their session activities and according to their availability. Once a session is initiated, a state server monitoring thread is created between the webserver and the state server to monitor and track the session occurring with the user. A monitoring thread as used here is software code application that, when executed by a processor, creates a mechanism for facilitating communication between the state server and a webserver so that the state server can send and receive signals to and from the webserver to monitor its activities. The state server can then determine whether the webserver is in service during a session between an application server and a browser. If that connection ever terminates, the state server will have retained relevant session information so that an application server may attempt to reconnect and possibly get rerouted to another webserver to continue a session.

Once a webserver is assigned, the system waits for one or more of the application servers 112-116 to send an authorization to make a connection with a user. This authorization may take the form of an initiation signal sent by an application server, indicating that the application server is ready to receive a browser request and possibly begin a session with a browser. Depending on the configuration of the application servers, a browser may request access to one or more application servers. Like the webservers, the application servers may have a matrix of multiple servers configured to handle incoming browser requests, and may also interoperate together to share sessions either in concert or as back-ups of each other. Then invention is not limited to any particular application server configuration, but, more importantly, is broad enough to be applicable to various such configurations.

Initially, a screening process may occur between the user web browser and the webserver in order to initially screen the user before it is given access to an application server. Once an application server sends an acknowledgment signal to a webserver, the application server has indicated that it is prepared to receive a communication connection from a user that has sent a browser request and directed for that particular application server or associated group of servers.

A screening process may also occur between the webserver and the application server in order for each of the entities to verify each other, so that proper verification can occur to establish the session between the application server and the user sending a browser request. A browser may have been preauthorized to access an application server before sending a request for access to the server. This would streamline the acceptance process between the browser and the webserver. Once this verification is completed, a webserver monitoring thread is created between a webserver and the application server so that the webserver can monitor the application server during the session. Here, monitoring thread is a software code application that, when executed by a processor, creates a mechanism for facilitating communication between the application server and a webserver so that the webserver can send and receive signals to and from the application server to monitor its activities. The webserver can then determine whether the application server is in service during a session between an application server and a browser. If that connection ever terminates or is somehow delayed, the application server may attempt to reconnect and possibly get rerouted to the same webserver to continue the session.

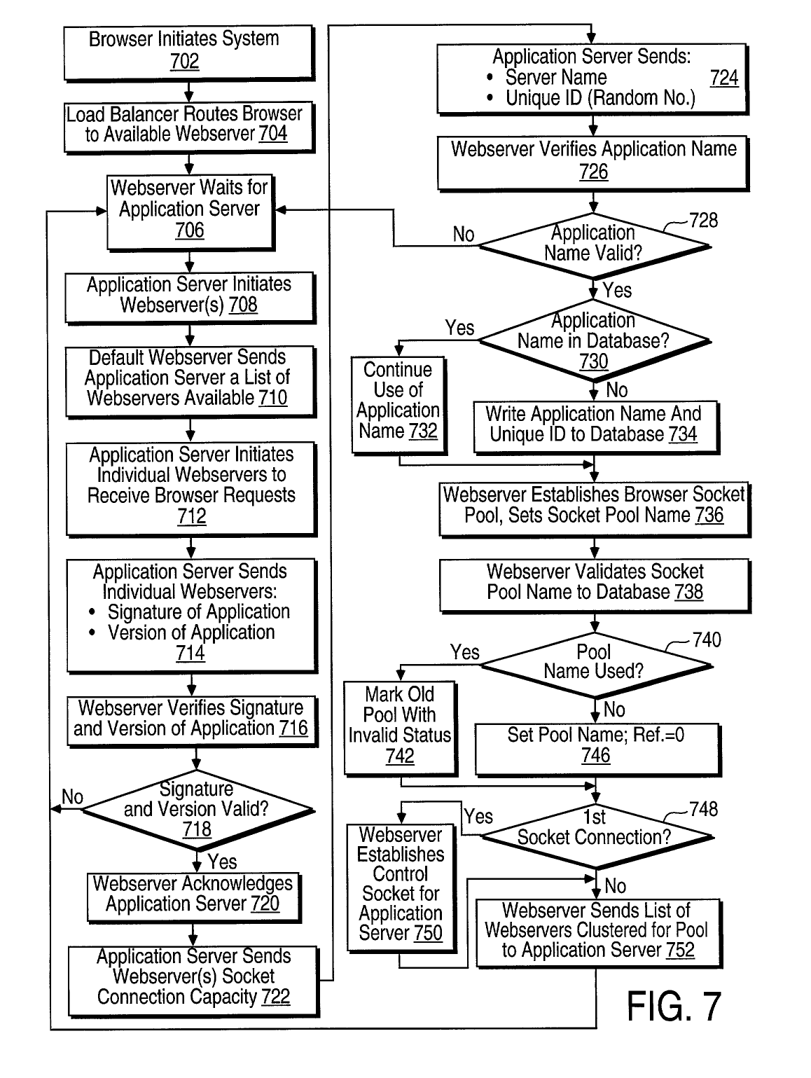

Similarly, the application server may establish an application server monitoring thread in order to monitor the webserver to insure that the application server is in constant contact with an available webserver. Here, a monitoring thread is a software code application that, when executed by a processor, creates a mechanism for facilitating communication between the application server and a webserver so that the application server can send and receive signals to and from the webserver to monitor its activities. The application server can then determine whether the webserver is in service during a session between an application server and a browser. If that connection ever terminates, the application server may attempt to reconnect and possibly get rerouted to another webserver to continue a session. This could occur, for example, in the event that the current webserver is shutdown during the session. These and other functions are discussed below in more detail with reference to the flowcharts illustrated in FIGS. 7-13.

Referring now to FIG. 7, the initiation process of a browser according to the invention is illustrated. In the first instance, a browser initiates the system in step 702. Referring to FIG. 1 again, a user, such as user 102, may send a browser request over the network, such as the Internet 108, intended to access an application server, such as application server 112. The request, however, does not go directly to the application server, but rather is directed to load balancer 128 via communication link 120. This routing may be accomplished by requiring that the address of the application server actually be the public Internet address of the load balancer, so that it is properly delivered according to conventional Internet protocol. The destination request of the browser request could also be a public IP Internet address of a proxy server communicating with Intranet 124, within which the webserver system 118 is interconnected. Other network interface configurations may also be possible for routing the browser requests to a webserver.

Still referring to FIG. 7, the load balancer then routes the browser request to an available webserver in step 704. Referring again to FIG. 1, load balancer 128 then sends the browser request to an available webserver, such as webserver 130. Referring again to FIG. 2, the load balancer receives the browser request at the browser interface 202. Using the traffic flow rate measure 204, the load balancer chooses an available webserver and routes the browser request to the webserver with the webserver interface 206. Referring again to FIG. 1, the load balancer then sends the request to the webserver 130, for example, via the bus 126.

Referring again to FIG. 3, at this step (step 704 of FIG. 7), the webserver 130 receives the browser request at load balancer interface 310 from the load balancer 128. Browser interface application 316 performs the initial screening process to identify and verify the user sending the browser request. Within the session data storage 324, the webserver stores the session data, which, in this step, includes the browser data from the user sending the browser request. This information may include the address of the browser and the browser's Internet cookie. By executing the browser interface application 316 with the CPU, the webserver can then verify the user. This verification of the user may include identification of the application server to which the browser request was directed, along with the identification data of the user. This verification process may verify a user according to different webservers and also different application servers. For example, according to a predetermined protocol, an application server may want to very closely screen a user in order to avoid unauthorized access to the application server's services or other sensitive information.

For example, an application server may provide services that exchange information between manufacturers and suppliers, including information pertaining to prices, supplies and other contractual terms. Accordingly, the parties to this information transaction would be very sensitive to unauthorized access of the information and would require protection from unauthorized users. The browser interface application 316 would perform this verification, screening and verifying the user according to the browser requests that the user sends.

Referring to FIG. 7, once the user is verified according to the browser request, the webserver waits in a holding pattern for an authorization from an application server, step 706. At this point, the state server 136, FIG. 1, creates a monitoring thread to the webserver and monitors the session between webserver and the browser variant. Referring again to FIG. 5, by executing codes stored in memory 508 with the CPU 502, the state server stores the session identification, which is established when an application server is connected. The state server also stores the user ID, which is taken from the browser requests during the verification process of the webserver, as well as other information pertaining to the session.

Referring again to FIG. 7, the process continues when an application server initiates the webserver in Step 708. Referring again to FIG. 4, the application server 112 executes the webserver interface application 412 using CPU 402. The application server sends a signal to the webserver through the modem 424 via the Network 108, authorizing the beginning of a session. This authorization allows the webserver to verify the application server and begin the session between users that send authorized and verified browser requests and the application server to which the requests are directed. At this step in the process, the application server is acting as a client to the webserver, and the webserver is acting as an application server to the application server. Once the signal is received by the webserver, these roles reverse, and the application server becomes, itself an application server, and the webserver becomes a client of the application server 112. Referring again to FIG. 1, the application server, such as application server 112, sends a signal via the network 108 and through communication link 122 to the bus 126 and ultimately to a webserver 130, where the verification process begins.

Referring again to FIG. 7, a default webserver, which first receives the initial signal from the application server, sends the application server a list of available webservers in step 710. This connection may also have been made via the load balancer 128, which could direct the signal or message from the application server to an available webserver. The webserver receiving the signal or message from the application server would necessarily need to have available the current state and availability of the other webservers so that the application server can be properly re-directed. This information may be stored in individual webservers that share this information or could also be stored in data base 138, which is readily accessible by any of the webservers connected to the bus 126. The webserver system 118, which includes the webservers, the state server, the load balancer and the database interconnected with the bus 126, may be organized in a fashion of optimum efficiency. The webserver system may also be designed according to the amount of data flow occurring between the users 102-106 and the application servers 112-116 via the webserver system 118. The webserver 118 manages the data flow among the entities.

Still referring to FIG. 7, in Step 712, the application server initiates individual webservers in order to receive browser requests. Referring to FIG. 6, during the initiation process, the application servers 112-116 communicate in one direction, toward the webservers 130-134. This protects the individual application servers from direct access by unauthorized users that are not screened by the webserver system 118 (FIG. 1). Once the screening process is completed, the communication between the application servers and the webservers are two way communications, which are closely monitored.

The application server may then send a signature of the application to the individual webservers, which securely identifies the particular application in a manner that is recognizable by the webserver. This signature may be used by the webserver to authorize browsers. As a configuration, the protocols are preferably predetermined in order to expedite this process. In fact, the webservers and application servers may be co-located, where the webservers simply screen and track browser requests directed to the application servers. Information identifying the version of the application is also sent by the application server to the individual webservers in Step 714 for further verification. Again, in a preferred embodiment, the version as well as the signature are predetermined between the webservers and the application servers. Referring to FIG. 3, the webserver 130 includes an application server interface application 320 stored in memory. The interface application 320, when executed by the CPU 302, interfaces with the application server in order to receive the signature and version of the application for verification. In Step 716, FIG. 7, the webserver verifies the signature inversion of the application.

Moving on to Step 718, a query is made as to whether the signature and version of the application is valid. If one or the other is not valid, the process returns to Step 706, where the webserver further waits for another initiation by an application server. If the signature and version are verified as valid, the process proceeds to Step 720, where the webserver acknowledges the application servers. In response, in Step 722, the application server sends the webserver(s)' the application server's socket connection capacity. This informs the webservers of the capacity of the application server to receive browser requests from users. The application server then sends its server name and unique ID, which may be a random number identifying the particular session, in Step 724. This is another level of verification of the application server to the webserver. Although it is often the case that application servers wish to be protected from unfriendly users, it may also be useful when the webservers and users are protected from unfriendly application servers that may cause harm as well. The webserver then verifies the application server's name and unique ID in Step 726. If the application name is not valid, the process returns to Step 706 where the webserver again waits for a new application server to respond. If the application name is verified in Step 728, a query is then made as to whether the application name is located in data base 138 (FIG. 1), at Step 730. If the application name is found in a database, the process proceeds to Step 732, where the system continues to use the application that was previously identified. If, however, the application name is not in a database, Step 730 proceeds to Step 734 where the application name and unique ID are written to the database for future reference. In either event, the process proceeds to Step 736 where the webserver establishes a browser socket pool and sets a socket pool name.

Establishing the socket pool defines the users that have access to the particular application server according to their access privileges, which, as discussed above, may be predetermined by the application server. As also discussed above, these privileges may also be predetermined between the users and the application servers before access to the system is made. The process then proceeds to Step 738 where the webserver validates the socket pool name to the database. This helps to avoid the names being repeated. If the pool name has not been used, the pool name is set in a database in Step 746. If the pool name has been used, the old pool is marked with an invalid status, assuming it is invalid in Step 742. Otherwise, a new name is established for the socket pool.

Still referring to FIG. 7 and continuing to Step 748, a query is made to determine whether this is the first socket connection for the particular application server. If it is the first connection, the process proceeds to Step 750, where the webserver establishes a control socket for the application server and records it in the database. In either case, the process proceeds to Step 752, where the webserver sends a list of webservers clustered for the socket pool to the application server. This establishes the particular webservers that will be serving browser requests to the application server, where the browser requests are screened and verified. The process then proceeds back to Step 706 where the webserver waits for another application server.

Either or all of the webservers may act as a default webserver for this screening process. Also, these webservers could receive the request from the application server through the load balancer 128, which determines which webserver will receive the responses and respond accordingly. In a preferred embodiment, however, the identities of the webservers are known to the application servers, and the protocol used for the prescreening process is streamlined. It may also be found to be more efficient to have different accesses to the network 108, such as the Internet, to better manage and secure data flow. In a preferred embodiment, it may also be helpful for the browsers themselves to be preauthorized for access to the application server. This would further streamline the validation process for the browser.

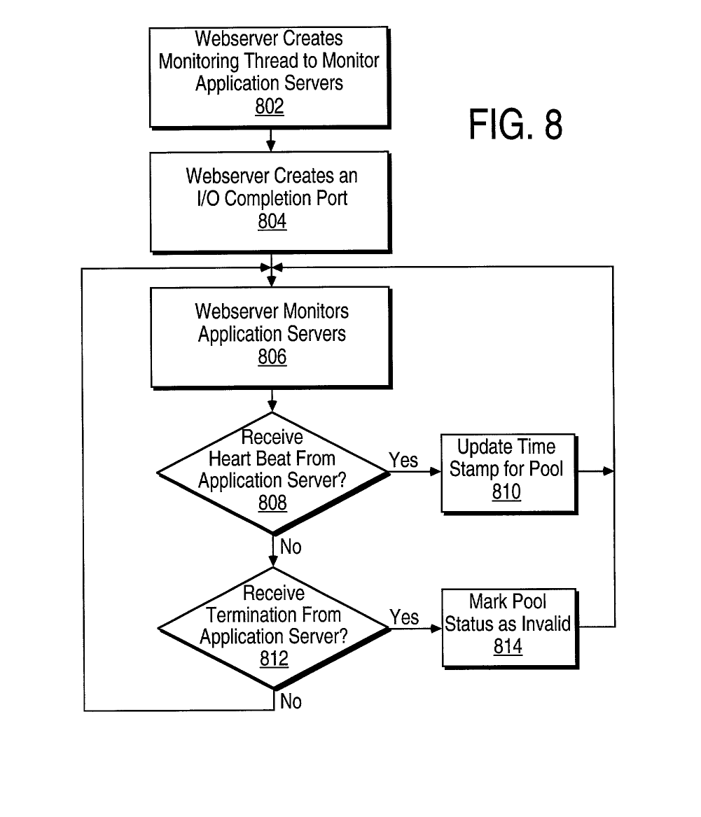

It is useful for the webserver to monitor the application servers in order to determine whether the application servers terminate the connection with the webserver. Referring to FIG. 8, a flow diagram is shown to illustrate such a process. In Step 802, the webserver creates a monitoring thread to monitor the application servers once each session begins. This monitoring thread may be an occasional signal or message sent, either referred to as the heartbeat of the application server. This signal, or heartbeat, may be sent to the application server. For security, a preferred embodiment would require an acknowledgement sent to the application server, indicating that the application server is still active and communicative. The webserver then creates an input/output completion port configured to receive a signal or message from the application server indicating termination of a session. In Step 806, the webserver monitors the application servers. The webserver receives a heartbeat signal or message from the application server in Step 808, indicating whether the session is continuing. If the heartbeat is received, the process proceeds to Step 810 where the time stamp for the socket pool is updated, this updates the status of the application server during the session. If the heartbeat is not received from the application server, the process proceeds to Step 812, where it will determine whether a termination signal or message has been received from the application server. If no termination signal was received from an application server, the process proceeds back to Step 806, where the webserver continues to monitor the application servers. If, however, the application server receives a termination signal or message, the process proceeds to Step 814 where the status of the socket pool is marked as invalid in a database. The process then returns to Step 806 where the webserver continues to monitor the application servers.

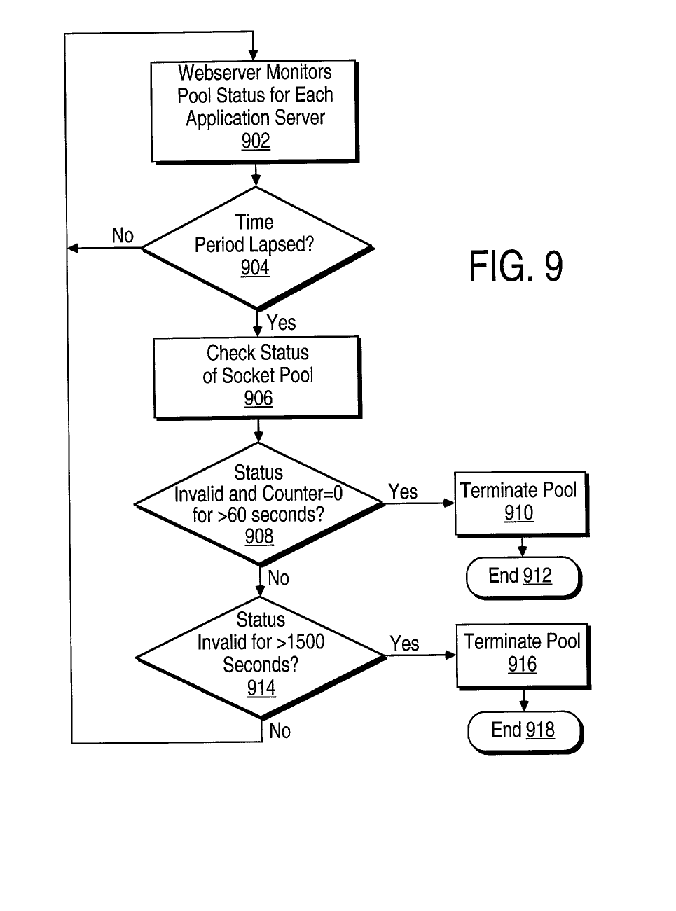

Step 806 in FIG. 8 is expanded into more detail in FIG. 9, illustrating the sequence and an example of timing involved in sending monitoring signals between the application servers and the webserver monitoring them. In Step 902, the webserver monitors the pool status for each application server. In Step 904, once a predetermined time period has lapsed, the webserver checks the status of the socket pool in Step 906 to determine whether or not the application server is still active. In Step 908, it is determined whether or not the status of the socket pool is invalid, and also whether the data counter is zero for greater than a predetermined time period, such as sixty seconds, for example. If all these are true, the process proceeds to Step 910 and the status pool is terminated, ending the process in Step 912. Otherwise, the process proceeds to Step 914 to determine whether or not the status has been invalid for more than 1500 seconds, or some other predetermined time. If this is not true, the process returns to Step 902 where the webserver continues to monitor the pool status for each application server. If it is true, the process proceeds to Step 916 to terminate the pool, which ends at Step 918.

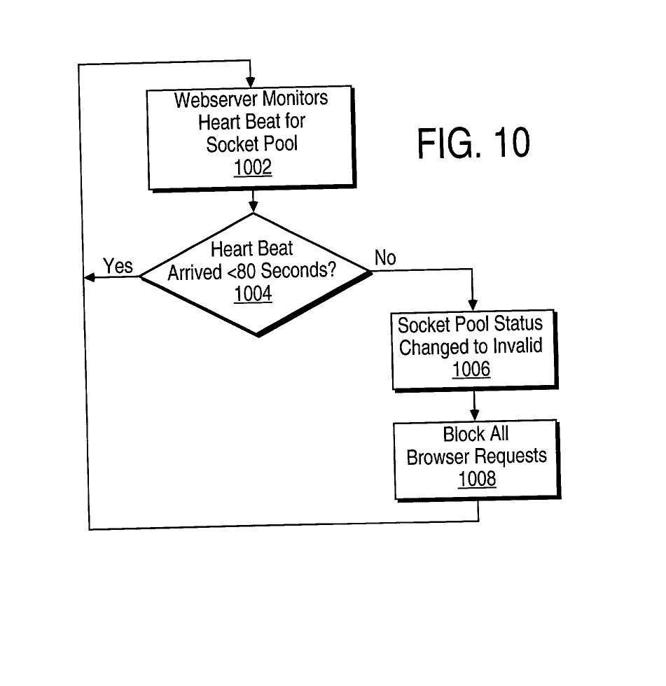

Similarly, the webserver monitors the heartbeat of an application server in Step 808 of FIG. 8, which is expanded to more detail in FIG. 10. While monitoring the heartbeat for the socket pool, the webserver waits for a predetermined time for the heartbeat to arrive in step 1004, indicating that the application server is still active. It continues to monitor the heartbeat of the socket pool until a predetermined time passes, such as eighty seconds. If the heartbeat has not been received over this predetermined period, the socket pool status is changed to invalid in Step 1006 and all browser requests are blocked in Step 1008. Monitoring is then continued in step 1002.

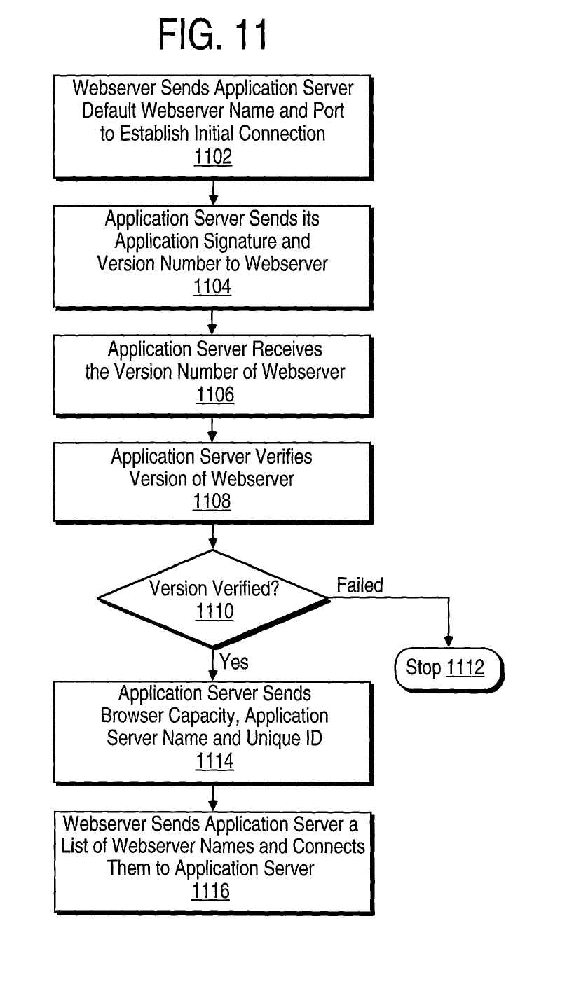

It is also useful for the application servers to monitor and interface with the webservers so that the application server can verify and monitor the webservers from their end. Referring to FIG. 11, a flow chart is shown to illustrate the verification on the application server and the process that occurs when a webserver connects with the application server. In Step 1102, the webserver sends an application server a default webserver name and port number to establish the initial connection. This default webserver will perform the screening procedures discussed above in order to establish the session protocol between users and application servers. The process proceeds to Step 1104, where the application server sends its application signature and version number to the webserver. In response, the application server receives the version number of the webserver in Step 1106. The application server then verifies the version of the webserver in Step 1108 according to a stored version list of webservers. This list of webservers may be stored in the webserver interface application 412 of the application server (FIG. 4). If the version is not verified, then the process stops at step 1110 and the connection to the webserver is terminated at Step 1112. If, however, the version is actually verified, the process proceeds to Step 1114 where the application server sends its browser capacity, application server name and unique ID to the webserver. In response, the webserver sends the application server a list of webserver names and connects them to the prescribed application server in step 1116.

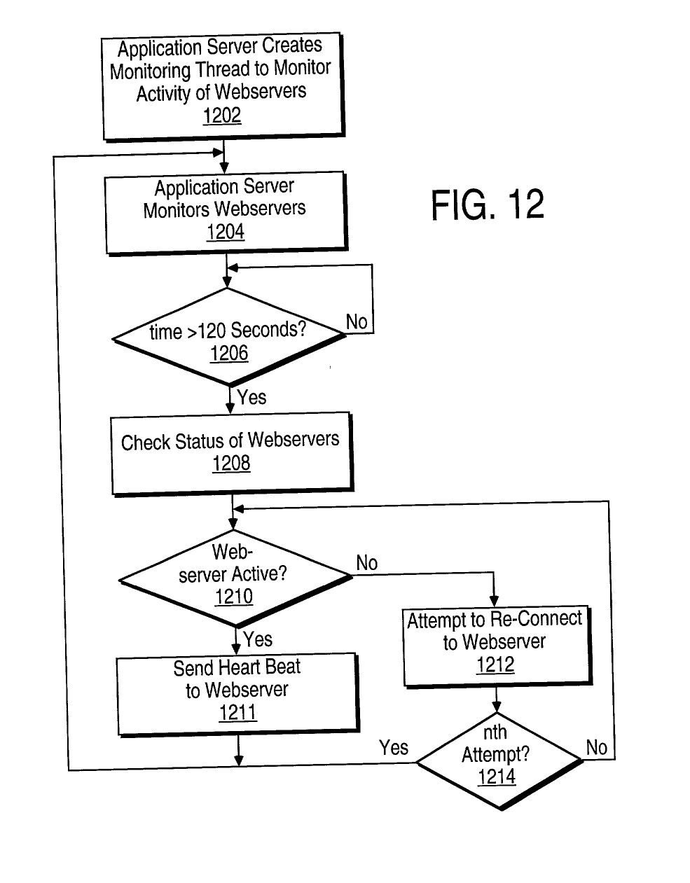

Similar to the webserver, it is also important for the application server to monitor the webservers. Referring to FIG. 12, such a monitoring process is illustrated in the flow diagram. In Step 1202, the application server creates a monitoring thread to monitor the activity of the webservers. This thread may be a sequence of signals or messages sent between the application server and the webserver, indicating the status of the webserver. In the event that a webserver fails, it is important that the application server is aware of the failure. The application server can then try to reconnect or find another webserver that may be in the application server's cluster to service the application server with browser requests. In Step 1204, the application server monitors the webservers. Over a predetermined amount of time, such as one hundred twenty seconds, in Step 1206, the application server checks the status of the webservers in Step 1208. If the webserver is found to be active in Step 1210, a heartbeat signal or message is sent to the webserver, indicating to the webserver that the application server is active. If, however, the webserver is not active, Step 1210 proceeds to Step 1212 and attempts to reconnect the webserver. Upon a predetermined number of attempts to reconnect in Step 1214, the process proceeds back to Step 1204, where the application server continues to monitor the webservers. At this point, the webserver is inactive. If the socket pool capacity of the application server still requires it, another webserver may need to be connected to the application server to continue the service. Once another webserver is verified and communicating with the application server, the application server can then continue monitoring the new webserver in step 1204.

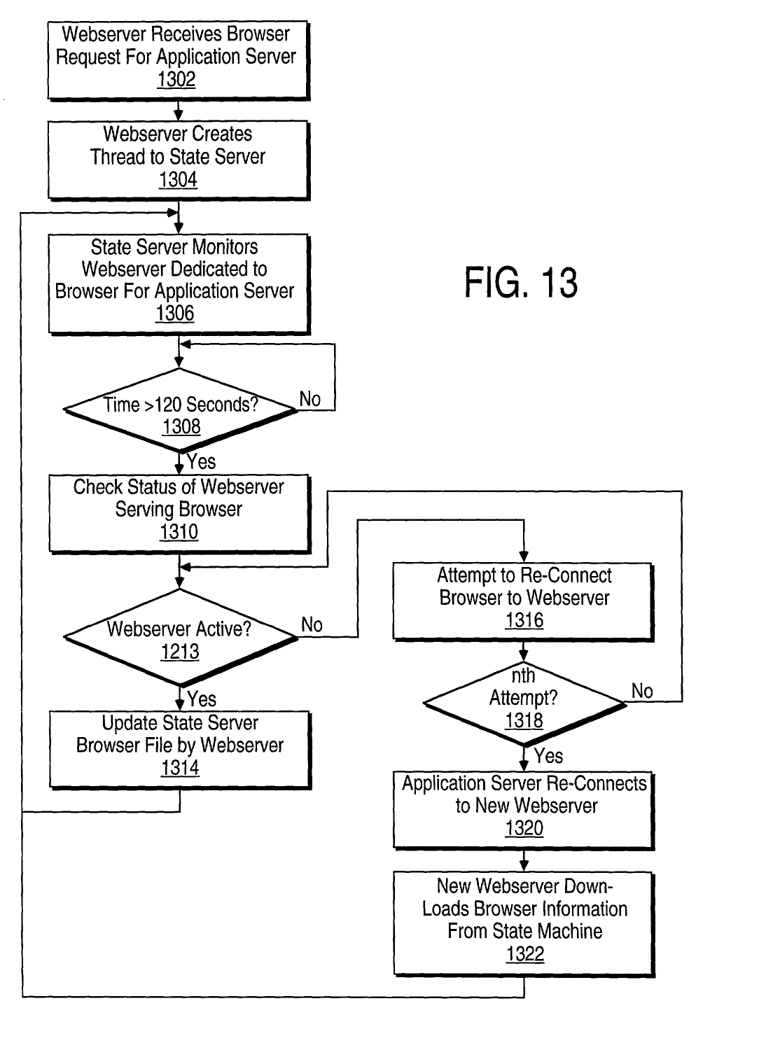

As an example of how a webserver can be replaced by another webserver upon failure of the first webserver, FIG. 13 illustrates such a scenario. The webserver receives a browser request from a user for an application server in Step 1302. The process then proceeds to Step 1304 where the webserver creates a monitoring thread to the state server so that the state server can monitor the session between the users sending browser requests and the application servers. The process then proceeds to Step 1306, where the state server monitors the webserver dedicated to the browser for the application server during the session. Over a predetermined amount of time in Step 1308, the application server checks the status of the webserver serving the browser during the session in Step 1310. If the web browser is found active in Step 1312, the state server is updated as to the status of the webserver. The browser file is then updated in the state server. The process then proceeds back to Step 1306 where the state server continues to monitor the webservers clustered for the application server. If, however, the webserver is found inactive in Step 1312, an attempt is made to reconnect the browser to the webserver in Step 1316. After a predetermined number of attempts in Step 1318, the application server reconnects to a new webserver in Step 1320. In Step 1322, the new webserver downloads the browser information from the state machine, which was stored during the session between the browser and the former webserver serving up the browser requests to the application server. This information is downloaded to the new webserver and the session continues. The process then returns back to Step 1306 where the state server continues to monitor the new webserver dedicated to the browser for serving up browser requests.

The invention is directed to a system and method for facilitating secure communication between a web browser and an application server. The invention may include dedicated processors, webservers configured to receive and route browser requests, application servers, state servers and other types of computer processors configured to communicate amongst each other and that may be connected to one or more networks, including a Local Area Network (LAN), an intranet and the Internet. However, it will be appreciated by those skilled in the art, that this is illustrative of only one utility of the invention, and that the invention has greater applicability and utility in many other applications where efficient routing and processing of data for performing online transactions within one or more networks is involved. Equivalent structures embodying the invention could be configured for such applications without diverting from the spirit and scope of the invention. Although this embodiment is described and illustrated in the context of devices and systems for receiving and routing communications between network browsers and application servers, the invention extends to other applications where similar features are useful. Furthermore, while the foregoing description has been with reference to particular embodiments of the invention, it will be appreciated that these are only illustrative of the invention and that changes may be made to those embodiments without departing from the principles of the invention, the scope of which may be defined by the appended claims. The invention may include application servers, state servers and Internet webservers that are designed and implemented on a computer and may be connected to a network for communication with other computers to practice the invention. A system configured to operate according to the invention may include a plurality of personal computers connected to the Internet via individual modems or other communication means such as wireless communications.

The invention may involve a number of functions to be performed by a computer processor, such as a microprocessor. The microprocessor may be a specialized or dedicated microprocessor that is configured to perform particular tasks by executing machine readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of servers that utilize the invention, there exist different types of memory devices for storing and retrieving information while performing functions according to the invention. Cache memory devices are often included in such servers for use by the central processing unit as a convenient storage location for information that is frequently stored and retrieved. Similarly, a persistent memory is also frequently used with such servers for maintaining information that is frequently retrieved by a central processing unit, but that is not often altered within the persistent memory, unlike the cache memory. Main memory is also included in such servers for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, nor any commonly used protocol for storing and retrieving information to and from these memory devices respectively.

The invention is directed to a system and method for receiving, screening, verifying and serving browser requests to an application server. It will be appreciated by those skilled in the art, that the embodiments described above are illustrative of only finite utility of the invention, and that the invention has greater applicability and utility in many other applications where efficient routing and processing of data within one or more networks is involved. Equivalent structures embodying the invention could be configured for such applications without diverting from the spirit and scope of the invention as defined in the appended claims. Although this embodiment is described and illustrated in the context of application servers being served browser requests, the invention extends to other applications where similar features are useful. Furthermore, while the foregoing description has been with reference to particular embodiments of the invention, it will be appreciated that these are only illustrative of the invention and that changes may be made to those embodiments without departing from the principles of the invention, the scope of which is defined by the appended claims.

1. A system for facilitating communication between a web browser and an application server via an intermediate webserver, comprising:
a webserver configured to communicate with a network, the webserver having an application server interface for communicating with an application server and a network interface for communicating with entities via a network; and
a state server configured to store data related to communication sessions occurring among a web browser, a webserver and an application server, the state server including a communication interface configured to communicate with the webserver;
an application server interface configured to communicate with an application server, the application interface including a mechanism for receiving a signal from an application server indicating an authorization to communicate with the application server.

2. A system according to claim 1, wherein the application server interface is configured to communicate with an application server only when a signal is received by the webserver that authorizes such communication.

3. A system according to claim 2, wherein the application server interface includes a monitoring mechanism for monitoring the activity of the application server during a session with a browser.

4. A system according to claim 2, wherein the application server interface includes a monitoring thread from for facilitating the monitoring by the webserver of the activity of the application server during a session with a browser.

5. A system according to claim 2, wherein the application server interface is further configured to receive a monitoring thread from an application server so that the webserver can monitor the activities of a application server during a session between the application server and a browser.

6. A system according to claim 2, wherein the application server interface is further configured with a monitoring mechanism that allows an application server to monitor the activities of a webserver during a session between the application server and a browser.

7. A system according to claim 2, wherein the application server interface is further configured to receive a monitoring thread from an application server so that an application server can monitor the activities of a webserver during a session between the application server and a browser.

8. A system according to claim 2, further comprising a second webserver communicating with the other webserver and with the state server, wherein the second webserver is further configured to take over a session occurring between the application server and a browser being monitored by the other webserver in the event the other webserver stops monitoring the session.

9. A system according to claim 8, wherein the second webserver is configured to take over a session occurring between the application server and a browser being monitored by the other webserver, wherein the application server interface includes a monitoring mechanism that is configured to engage the second webserver to monitor the session between the application server and the browser after the application server sends a signal in the event the other webserver stops monitoring the session.

10. A system according to claim 8, wherein the second webserver is configured to take over a session occurring between the application server and a browser being monitored by the other webserver, wherein the application server interface includes a monitoring mechanism that is configured to engage the second webserver to monitor the session between the application server and the browser only after the application server sends a signal in the event the other webserver stops monitoring the session.

11. A system for communicating among a plurality of network servers communicating with a plurality of computers, comprising:
a plurality of webservers communicating with and configured to receive a request from a web browser and to screen and route the browser request to an application server upon the receipt of a signal from the application server;
an application server interface configured to control communication between the plurality of webservers and an application server;
a state server configured to store data related to communication sessions occurring among a web browser, a webserver and an application server, wherein a first webserver is configured to retrieve information related to a session between a web browser and an application server and being monitored by a second webserver in the event that the second webserver terminates its monitoring of the session.

12. A system according to claim 11 further comprising a database communicating with the state server and configured to store session information.

13. A system according to claim 11, wherein the webserver is configured to route a browser request to an application server only upon the receipt of a signal from the application server.

14. A system according to claim 11 further comprising a load balancing device configured to receive browser requests sent from computers communicating with the network system and to direct the requests among the plurality of webservers.

15. A method of facilitating communication between a web browser and an application server, comprising:
receiving a request for access to an application server;
receiving the request by a first webserver;
screening the request for determining authority to access the application server;
receiving a signal from the application server indicating that it is ready to receive a browser request;
communicating with the application server to create a monitoring thread between the webserver and the application server; and
facilitating communication between the browser and the application server with the webserver.

16. A method according to claim 15, further comprising:
communicating with a state server to create a monitoring mechanism between the webserver and the state server to monitor communications between a web browser and an application server and to store information related to such communications.

17. A method according to claim 15, further comprising:
routing the incoming browser request to one of a plurality of webservers;
receiving the request by a first webserver; and
transferring identification information related to other webservers to the application server.

18. A method according to claim 15, wherein the step of facilitating communication between the application server and the webserver includes facilitating a session of communication between the application server and the webserver.

19. A method according to claim 15, wherein facilitating communication between the browser and the application server with the webserver is done in response to receiving a signal from the application server indicating that it is ready to receive a browser request.

21. A method according to claim 15, wherein the step of facilitating communication between the application server and the webserver includes facilitating a session of communication between the application server and the webserver.

22. A method according to claim 20, further comprising:
routing the incoming browser request to one of a plurality of webservers;
receiving the request by a first webserver;
communicating with a state server to create a monitoring thread between the first webserver and the state server so that the state server can monitor communications between the web browser, the first webserver and the application server;
transferring identification information related to other webservers to the application server;
receiving a monitoring signal from the application server;
receiving a signal from the application server indicating that a webserver has terminated the monitoring of the session;
receiving a signal at a second webserver from the application server indicating a desire to reconnect to another webserver, wherein signal includes identification information of the second webserver;
transferring session data from the state server to the second webserver;
communicating with a state server to create a monitoring thread between the second webserver and the state server so that the state server can monitor communications between the web browser, the first webserver and the application server;
facilitating a continuing session between the application server and the web browser.
